(19) United States
(12) Patent Application Publication
(10) Pub. No.: US 2007/0247691 A1
(43) Pub. Date: Oct. 25, 2007

(54) Variable Diaphragm, Lighting Device, Optical Observation Device as Well as Optical Observation Apparatus

(76) Inventors: Andreas Obrebski, Dusseldorf (DE); Anton Moffat, Jena (DE); Markus Strehle, Jena (DE)

Correspondence Address: KRIEGSMAN & KRIEGSMAN, 30 TURNPIKE ROAD, SUITE 9, SOUTHBOROUGH, MA, 01772, US

(21) Appl. No.: 11/630,290

(22) PCT Filed: Jun. 15, 2005
(86) PCT No.: PCT/EP05/06406

§ 371 Date: Dec. 18, 2006

(30) Foreign Application Priority Data
Jun. 16, 2004 (DE) 10 2004 029 056.3

(51) Int. Cl. G02B 26/02

(52) U.S. Cl. 359/228; 359/227; 359/230

(57) ABSTRACT

Among other things, a variable diaphragm is described for a lighting device and/or for an observation device inside an optical observation apparatus for imaging an object and/or an intermediate image produced by an object, particularly for a stereoscopic observation apparatus, wherein the variable diaphragm is provided for at least one beam path of the lighting device and/or for a beam path of the observation device. According to the invention, the variable diaphragm can be controlled in order to produce a specific lighting geometry by regions. In addition, the variable diaphragm is formed for the utilization of all directions of polarization of the light of a light source. Further, a lighting device, an optical observation device, as well as an optical observation apparatus are also described.

The present invention relates first to a variable diaphragm for a lighting device and/or an observation device according to the preamble of patent claim 1. In addition, the invention relates to a lighting device for producing a patterned illumination for an optical observation apparatus according to the preamble of patent claim 15 as well as an optical observation device according to the preamble of patent claim 27. Finally, the present invention also relates to an optical observation apparatus according to the preamble of patent claim 42.

Lighting devices, observation devices as well as observation apparatuses of the named type are known in multiple variations from the prior art. In one design variant an observation apparatus may be, for example, a microscope, e.g., a stereomicroscope. Such microscopes may be constructed, among other things, as operating microscopes, for example, in the form of a so-called opthalmologic microscope for conducting eye surgeries. A lighting device may be provided in order to produce a suitable illumination beam path for working with the operating microscope.

In microscopy, particularly in operating microscopes, it is often desired to illuminate specific regions in a targeted manner and, on the other hand, to exclude other regions from the illumination. For example, it is desired in opthalmology that the sometimes colored red reflex illumination is only coupled to the pupil, and that the surgical field is not falsely colored. In contrast, the illumination of the surgical field must not enter the pupil, so that the retina is not additionally stressed.

For protection of the retina of the patient's eye during an operation under an operating microscope, non-transparent gelatin disks or a black spot are used for this purpose in the illumination of the microscope, in order to prevent too much light from reaching the retina of the patient, which would lead to irreversible damage therein.

In cataract operations, after removing the lens of the eye, it is necessary to completely aspirate all residue of the defective lens. For this purpose, so-called regredient illumination [back lighting], in which light irradiated onto the retina through the pupil is reflected therein and the lens residue that still remains is illuminated from behind, so that this residue is more readily recognized, has proven effective under the microscope. In this case, light perceptions that are reflected into the microscope from the field surrounding the pupil are disruptive to the surgeon.

In operations in very small areas, the microscopic image is adversely affected by light reflected from the surrounding areas. When the illuminated field is reduced exclusively to such a small area, however, the surgeon can easily lose his overview as it relates to the position of important detail in the overall surgical field.

In order to overcome this problem, a light trap for apparatuses for eye examination has been described in DE 33 39 172 A1. The light trap achieves a reduction of the stress on the patient during eye surgery by preventing the light beam of a lighting beam path from impinging on the retina. According to this solution, it is provided that a light-absorbing layer is disposed in the central region of the lighting beam path in a plane conjugated to the object plane, and this layer is appropriately designed as the light-impermeable central part of an annular diaphragm aperture. In this way, a central shading is made possible, which advantageously corresponds to the diameter of the pupil of the patient. It is a disadvantage, however, in this known solution, that the projected black spot is invariable and has a constant diameter. In addition, the light trap is found in a rigid, unchangeable position inside the lighting beam path.

In another solution which is known from the prior art, DE 196 44 662 A1, a lighting device is described for a microscope, wherein the lighting device has a light source and an illumination optics. In the lighting beam path of the microscope, an element is provided for producing a variable aperture for light incidence (named variable diaphragm in the following), which is formed by a matrix of points that can be switched on, whereby the light emitted from the light source is deflected onto an object by means of the at least one variable diaphragm. The variable diaphragm involves a so-called LCD matrix.

An LCD (liquid crystal display) matrix generally involves a liquid crystal display in the form of a passive electro-optical transformer, which means that extraneous light is necessary. Such a liquid crystal display is based on the fundamental mode of operation that liquid crystals form in specific organic chemical substances. In a specific temperature region, these substances have a crystalline fluid state in which, on the one hand, they are in fact liquid, but, on the other hand, the crystal structure is still present in the geometric arrangement of the molecules. In this crystalline fluid phase, these substances can be influenced by electrical fields. Any desired transparent/opaque pattern is produced on the LCD matrix by means of a control device in the known solution.

In DE 198 12 050 A1, an arrangement and a method for illumination are described for a stereoscopic ocular microscope, in which a variable diaphragm is also produced by an LCD matrix. This known solution describes an opthalmologic apparatus, such as a split lamp or a visus examining apparatus or a combination of the two, in which an LCD matrix is utilized for variable illumination of the patient's eye with light fields of different geometries. In this way, the illumination of the patient's eye is produced by means of LCD chips that can be controlled electronically relative to their light transmission, light reflection or light emission.

In the two known solutions described above, the variable diaphragm is found in the form of an LCD matrix of switchable points in the lighting beam path. It is also already generally known, however, from DE 103 00 925 A1 to provide a switchable diaphragm in the form of a liquid crystal diaphragm in the observation beam path of a microscope.

In all of the above-named cases, a light source is provided, which produces and emits nonpolarized light. A disadvantage in the solutions known from the prior art is that the LCD matrices used as variable diaphragms can in fact be controlled pointwise, but can operate only with polarized light. This means that a large part of the light intensity in the observation beam path or in the lighting beam path, respectively, is lost. In addition, the variable diaphragms known from the prior art are fixed within the respective beam paths.

Starting from the named prior art, the object of the present invention is to further develop the variable diaphragm, the lighting device as well as the optical observation device of the type named initially, in such a way that the disadvantages described above are avoided. In particular, solutions will be provided in which the elements used for producing a variable aperture for light incidence (variable diaphragm) can be operated with as little loss as possible and with the greatest variability possible.

The variable diaphragm according to the invention, the lighting device according to the invention, the optical observation device according to the invention, as well as the optical observation apparatus according to the invention are based on the common basic concept of the invention that the variable diaphragm is configured in a special manner. The variable diaphragm is configured such that it can be varied in a simple manner with respect to the geometry of the light field that it produces. In this way, the variable diaphragm is controlled—in particular, electronically—from the outside, preferably by a control device. In addition, the variable diaphragm according to the invention can be operated with reduced light loss. For this purpose, different embodiments for the variable diaphragm are proposed according to the present invention, but all of these can be subsumed under the common basic concept of the invention.

According to the invention, the object is solved by the variable diaphragm with the features according to independent patent claim 1, the lighting device with the features according to independent patent claim 15, the optical observation device with the features according to independent patent claim 27 as well as the optical observation apparatus with the features according to independent patent claim 42. Other advantages, features, details, aspects and effects of the invention result from the subclaims, the description, as well as the drawings. Features and details, which are described in connection with the variable diaphragm according to the invention, thus also apply, obviously, to the lighting device according to the invention and/or to the optical observation device according to the invention and vice versa. Likewise, features and details, which are described in connection with the lighting device according to the invention, thus also apply, obviously, to the optical observation device according to the invention and vice versa. The same applies also to the optical observation apparatus according to the invention.

According to a first aspect of the invention, a variable diaphragm is provided for a lighting device and/or an observation device within an optical observation apparatus for imaging an object and/or an intermediate image produced by an object. The variable diaphragm can thus be provided for at least one beam path of the lighting device or the observation device, or can be integrated in the latter. It is also possible, of course, that the variable diaphragm is provided or integrated, both in at least one beam path of the lighting device as well as also in at least one beam path of the observation device.

This variable diaphragm is characterized according to the invention in that it can be controlled by regions for producing a specific lighting geometry and that the variable diaphragm is configured for utilization of all directions of polarization of the light of a light source.

It is first provided according to the invention that the variable diaphragm is configured in such a way that a specific lighting geometry can be produced thereby—for example, in an object field. Here, of course, the invention is not limited to the generation of specific lighting geometries. Likewise, the lighting geometry can be variable, which means that it can be adapted to changing conditions during operation and can be modified correspondingly. Nonexclusive examples are explained in more detail for this purpose in the further course of the description.

Another basic feature provides that the variable diaphragm can be controlled at least by regions in order to be able to adjust the variable lighting geometries. The invention is thereby not limited to specific sizes and/or shapes of regions. In the simplest case, a single point can be controlled in such a way. In particular, if the variable diaphragm is formed of a matrix comprised of individual points, one or more points can be controlled individually or in groups, whereby in the last-named case, individual points can be combined into one region. Also, in this respect, the invention is not limited to concrete configurations.

Advantageously, it may also be provided that the variable diaphragm is configured in such a way that light of a light source that passes through it, for example, the illumination light—in particular in the region downstream of the variable diaphragm or in the place where the illumination light strikes the object to be illuminated—has an effectiveness of more than 40%. This means that light losses which are caused by polarization, such as was the case in several solutions of the prior art, are no longer present.

The variable diaphragm according to the invention provides a solution, whereby the lighting geometry can be modified locally, wherein, in particular, each point of a corresponding diaphragm matrix can stand alone and can be controlled independently. A particularly light-efficient diaphragm can be realized by the use of such a diaphragm.

Basically, the variable diaphragm is not limited to use in specific lighting devices or optical observation devices.

For example, the variable diaphragm can be configured for the reflection and/or transmission of light. Transmission of light means that a light beam can pass through the variable diaphragm. In this case, the variable diaphragm can be controlled preferably in such a way that the regions of the lighting geometry that are specific for the transmission of a light beam are switched on so as to be transparent, or at least permeable to light. If the variable diaphragm is configured for the reflection of light, a light beam strikes the surface of the diaphragm—preferably at a defined angle, and is reflected by the latter at a defined angle. In this case, the regions of the lighting geometry specific for reflection are switched on so that they are reflecting, for example, mirror-reflecting.

The invention is not limited to specific structural configurations for the variable diaphragm. Several nonexclusive examples will be explained in more detail below for this purpose.

It may be provided advantageously that the variable diaphragm is formed as an active optical element. This means that a light source is integrated into the variable diaphragm. In this case, the invention is not limited to specific types of light sources.

Preferably, the variable diaphragm is formed of a matrix of miniature light sources that can be switched on and off by regions. In this case, the miniature light sources are preferably of a size that is smaller than the overall arrangement of the total light source. The miniature light sources are preferably point light sources. Advantageously, each individual miniature light source can be controlled individually and independently of other miniature light sources, whereby in turn several miniature light sources can be or will be able to be combined into one light-source region.

The miniature light sources advantageously have a diameter of less than or equal to 2 cm, preferably of less than or equal to 1 cm, more preferably of less than or equal to 0.5 cm, and most particularly preferred of less than or equal to 0.2 cm.

The invention is not limited to specific types of miniature light sources. The variable diaphragm can be formed particularly advantageously from a matrix of light diodes (LEDs), in particular organic light diodes (OLEDs) that can be switched on by regions. Organic light diodes were originally developed as microdisplays. Unlike LCDs, which require a white (compact fluorescent) backlighting, OLEDs illuminate as Lambert radiators (surface or flat emitters).

As patterned lighting sources, OLEDs offer a good light efficiency and small patterns without intermediate dark spaces. A display of OLEDs or LEDs can be utilized, for example, in the plane of a diaphragm to be used. Depending on the desired lighting geometry, individual miniature light sources can be turned on and others can remain turned off. The filling factor is higher in OLEDs as opposed to LEDs, which means that a higher packing density can be realized. The use of a display of LEDs or OLEDs makes possible a programmable, and, for example, also an automatable switching of different illumination modes, without the necessity of moving mechanical components, such as, e.g., phase-contrast rings, filters, reducers and the like. Particularly suitable, for example, are white OLEDs, whose spectrum is determined by a mixture of organic molecules. Of course, colored OLEDs may also be used, which can be utilized, for example, for special lighting purposes (for example, red reflex illumination) or similar applications.

Of course, other types of miniature light sources may also be utilized, in particular one of the polarized light sources as mentioned above, such as, e.g., a laser or similar source.

According to another embodiment, the variable diaphragm can be configured, for example, as a passive optical element. This means that a light source is not integrated in the variable diaphragm, but rather the light source is disposed in the beam path, for example, in the lighting beam path and/or in the observation beam path, in front of the variable diaphragm. In this embodiment also, the invention is not limited to specific types of variable diaphragms. Several nonexclusive examples will be described below in this respect.

For example, the variable diaphragm may have a matrix of switchable points in the form of an LCD matrix. In this connection, reference is made also to the full content relative to the corresponding embodiments given below for the lighting device according to the invention, as well as for the observation device according to the invention.

In such a case, it must be assured that the light emitted by the light source is or will be polarized. This can be realized by use of a light source that is initially polarized. For example, it may also be provided that nonpolarized light is emitted in the beam path downstream of a light source, while in front of the variable diaphragm, a device is provided for the linear polarization (polarization device) of the light emitted from the light source. In this case, the invention is not limited to specific types of polarization devices or specific configurations of polarization devices. It is only important that the polarization device can polarize the emitted light with little loss of light. The polarization device is disposed according to the invention in front of the variable pupil in the lighting beam path.

In another configuration, the variable diaphragm can be formed on the basis of electrowetting. A pointwise controllable, light-efficient diaphragm can also be provided in this way. The variable diaphragm here is constructed in the form of a matrix of switchable points, wherein switching on can be achieved, for example, by control with electrical voltage. It is provided in this way that the principle of so-called electrowetting is used for the configuration of the variable diaphragm.

The principle of electrowetting is already known in and of itself and results, for example, from DE 698 04 119 T2. A drop of a nonconducting fluid* is provided, which is disposed on a dielectric substrate, which in turn covers a flat electrode. A voltage can be applied between the liquid conductor drop and the electrode. The wettability of the dielectric material relative to the conductor fluid changes thereby, whereby the wettability is essentially increased in the presence of an electrical field, which is caused by the voltage applied between the conductor fluid and the electrode.
* sic; conducting fluid?—Trans. Note.

A realization of the principle of electrowetting in a variable diaphragm can be provided by furnishing the latter with at least one uptake container, which contains a first medium that is flexible in shape and a second medium that is flexible in shape, whereby the media are immiscible and come into contact at an interface. In addition, means will be provided for changing the size and/or shape of the interface between the media. Basically, the invention is not limited to specific types of media. It is important only that the media are flexible in shape. In light of the present description, “flexible in shape” means that the media do not have a rigid surface, but rather that the media can change their shape inside the uptake container. For example, but not exclusively, the media that are flexible in shape may involve a liquid, a gel or the like. For example, but not exclusively, one of the media that are flexible in shape may be water or water containing additives such as salts and the like, and the other medium that is flexible in shape may be an oil.

Preferably, at least one of the media that are flexible in shape is partially transparent, while the other medium that is flexible in shape is not transparent. In order to exclude gravitational effects, the two media that are flexible in shape, for example, may have the same or at least a similar density.

The principle of electrowetting by generating an electrical field can now provide that the first medium that is flexible in shape and the second medium that is flexible in shape have different electrical conductivities. The medium with the lower electrical conductivity, for example, an oil, can be disposed between the medium with the higher electrical conductivity, for example, water or water containing additives as well as at least one electrode. In this way, it may be provided that the medium with the lower electrical conductivity is disposed on one surface of a substrate, while the at least one electrode is disposed on the other surface of the substrate. Now, if an electrical field is applied between the at least one electrode and the medium with the higher electrical conductivity, the interface between the two media that are flexible in shape will be changed in this way. Such a solution is described, for example, in WO 03/069380 A1, the disclosure content of which is fully incorporated in the description of the present invention.

The term electrowetting, in light of the present invention, will also be understood, of course, to include any other solution which functions according to the above-named principle, but in which a change of the interface is brought about by a means other than by applying an electrical field. In such a case, the means for changing the interface between the two media that are flexible in shape, for example, can be formed in such a way that these means exert a pressure on the first and/or second medium, whereby the interface between the two media changes due to the pressure exertion. Such means may be configured in a structurally simple, energy-saving manner, whereby such means often require only very small control voltages. For example, it is conceivable that the means for changing the interface are formed as mechanical means in such a case. For example, the means may involve a piston device or a cylinder device. In another configuration, it is also conceivable that the means for changing the interface are configured in the shape of a controllable membrane. Of course, the invention is not limited to the above-named examples.

A variable diaphragm, which functions according to the principle of electrowetting may be configured in a different way. For example, it is conceivable that the at least one variable diaphragm has a matrix of controllable points, in which the points are formed from a number of independent drops of one of the media that are flexible in shape, in particular the medium that is flexible in shape and has a lower electrical conductivity. In this case, the drops can be surrounded by the other medium that is flexible in shape, particularly the medium with a higher electrical conductivity. Of course, it is also conceivable in such a case that the medium that surrounds the drops of the other medium is air. A corresponding example in this regard is described in U.S. Pat. No. 5,659,330, the disclosure content of which is fully incorporated in the description of the present invention.

It may be provided in another configuration that one medium that is flexible in shape is not disposed in the form of drops, but in the form of a continuous film medium on a substrate. This medium particularly consists of a material with low electrical conductivity. The second medium that is flexible in shape, in particular a medium with higher electrical conductivity can then be found on top of this film medium. Now, if an electrical field is applied between an electrode and the first medium that is flexible in shape with the higher electrical conductivity, this means that the wettability changes for the medium that is flexible in shape and has the higher electrical conductivity. For example, this may lead to the fact that the film with the medium having the lower electrical conductivity is shifted to the side. If this film medium is formed, for example, of a non-transparent material, the coloration of the corresponding region of the variable diaphragm, for example, may change thereby. If it is provided, for example, that the walls bounding the uptake container are formed of a transparent material and if it is additionally assumed that a possible electrode is also formed from a transparent material, it can be achieved in this way that the variable diaphragm can be brought from the “light-impermeable” state to the “light-permeable” state, and vice-versa, at least by regions, by applying an electrical field.

In another configuration, it may also be provided that the at least one variable diaphragm has a matrix of controllable cells, wherein each cell is configured particularly in a way as described above. An arrangement in which such a cell matrix is described, is known, for example, from WO 03/071235 A2, the disclosure content of which is incorporated in the description of the present invention.

According to a second aspect of the invention, a lighting device is provided for producing a patterned illumination for an optical observation apparatus for imaging an object and/or an intermediate image produced by an object, in particular for a stereoscopic observation apparatus having a light source and having at least one variable diaphragm provided in a lighting beam path. The lighting device is characterized according to the invention by the fact that it has at least one variable diaphragm according to the invention as described above.

Reference is also made herewith to the full extent to the preceding embodiments given for the variable diaphragm according to the invention with respect to the advantages, effects, as well as the mode of operation of the lighting device according to the invention.

As was described above, at least one variable diaphragm, for example, can be configured as an active optical element. According to another embodiment, at least one variable diaphragm can be configured, for example, as a passive optical element. This means that the light source is disposed in the lighting beam path in front of the at least one variable diaphragm. The light emitted from the light source is then deflected onto an object to be illuminated by means of the at least one variable diaphragm.

It is also possible, of course, that at least one active variable diaphragm and also at least one passive variable diaphragm are provided in the lighting beam path.

Advantageously, an illumination optics can still be provided between the light source and the at least one variable diaphragm.

In such a case, it must be assured that the light emitted by the light source is or will be polarized. Thus, it may be provided, e.g., that a light source which is polarized from the outset, for example, a laser light source or similar source, is used. For example, it may also be provided in this respect, however, that a device is provided for linear polarization (polarization device) of the light emitted from the light source in the lighting beam path downstream from the light source, and in front of the variable diaphragm. For example, this is of advantage if the at least one variable diaphragm has a matrix of switchable points in the form of an LCD matrix.

The invention is not limited to specific types of polarization devices or specific configurations of polarization devices. It is only important that the polarization device can polarize the emitted light with little loss of light. According to the invention, the polarization device is disposed in front of the variable diaphragm in the lighting beam path.

Unlike the solution known from DE 196 44 662 A1, such a solution has an essentially greater effectiveness. As was set forth in the scope of the introduction to the description, the lighting device according to DE 196 44 662 A1 is operated with a light source which emits nonpolarized light. A particular device for the polarization of this light is not provided in the known solution, so that large light losses occur here.

Unlike the known solution, it is now provided according to the invention that the light is polarized before it reaches the variable diaphragm. In this way, an essentially higher effectiveness results in comparison to the solution known from the prior art, which lies in the range of a factor of 2.

For example, an ordinary nonpolarized light source can be utilized as the light source. The nonpolarized light emitted from this light source is then polarized with little loss by means of the polarization device, which will be explained in more detail in the further course of the description. Subsequently, the now polarized light enters into the variable diaphragm.

The variable diaphragm is preferably positioned in different planes depending on the application. For example, it can be provided in opthalmology that the variable diaphragm is placed in the same plane as the retinal guard diaphragm known from DE 33 39 172. In neurosurgery, the variable diaphragm could assure that light is only coupled in the deep surgical canal and that the skin and the surgical instruments are not disruptively bright. The same applies to the ear, nose and throat (ENT) field. In the dental field, reflections from the teeth and metal crowns could be reduced or suppressed with the lighting device according to the invention.

A particularly advantageous configuration of the lighting device provides that the lighting device is a component of an operating microscope and a combination of a variable diaphragm, which is disposed in a plane that is conjugated to the respective plane of interest within the lighting beam path, and a polarization device, whereby the polarization device functions as a converter of nonpolarized light to polarized light, is provided.

Advantageously, the lighting device may have one or more diaphragms. Here, individual diaphragms can be fixed, while other diaphragms are made variable in the way described above. The invention, however, is not limited to a specific number of diaphragms in the lighting beam path or to a specific configuration of the individual diaphragms. According to the invention, it is only necessary that at least one of the diaphragms will be configured as a variable diaphragm in the manner described above.

It may be advantageously provided that the LCD matrix is formed as at least one planar matrix with a number of opto-electronic LCD cells and means for the electronic control of the LCD cells are provided. Such a configuration of the LCD matrix makes it possible to control it in a particularly targeted manner in order to adjust suitable geometries of the light field. The more LCD cells present in the LCD matrix, the more accurate and finer can be the control of the variable diaphragm. The LCD matrix or the individual LCD cells, respectively, are preferably controlled electronically, for which purpose suitable means can be provided, e.g., in the form of a control device or similar means.

It may advantageously be provided that the polarization device is a component of the illumination optics and that such optical elements of the illumination optics, which may lie in the lighting beam path between the polarization device and the variable diaphragm, are configured as polarization-maintaining elements.

The invention is not limited to specific configurations of the polarization device. Several nonexclusive examples will be described below in this respect, whereby polarization devices have already become generally known from the prior art, but here in a different context.

As was already presented, when an LCD matrix is used as a variable diaphragm in a beam path, particularly a lighting beam path, especially in an operating microscope, linearly polarized light must be used. If a common, nonpolarized light source, as described, for example, in DE 196 44 662 A1, is used, then at least half of the radiation is lost, on the one hand, and the lighting device or an optical observation device coupled to the lighting device, respectively, on the other hand, can be thermally stressed. For this reason, it is desirable also to be able to utilize the “lost and gone” part of the radiation. The heat stress would thus clearly decrease and the light source could essentially be dimensioned smaller, which, on the one hand, means a cost savings, and on the other hand, makes possible the use of a larger bandwidth of light sources, such as, for example, also LEDs or similar sources.

In order to obtain a suitable linear polarization of the nonpolarized light emitted from the light source, it may first be provided that the polarization device has at least one beam splitter for splitting the light emitted from the light source into two or more partial beans with different directions of polarization. In this case, the invention is not limited to specific configurations for the beam splitter.

In addition, it may be provided, for example, that at least one other optical element is provided, disposed downstream from the at least one beam splitter, which is configured in a way so as to then cast the two separate partial beams of different polarity onto the LCD matrix adjacent to one another. With such a solution, the partial beams with different polarization are first spatially separated, but are then cast onto the LCD matrix in a directly adjacent spatial manner. With the knowledge of which pixels can be assigned to which polarization, individual regions of the LCD matrix, for example, individual LCD cells, can then be suitably controlled.

In another configuration, it may be provided that at least one optical element is provided downstream from the at least one beam splitter, and this optical element is configured in a way that the two separate partial beams of different polarity are each cast onto different LCD matrices. These LCD matrices can then be rotated by 90 degrees, for example, relative to one another and are suitably controlled. Such a solution is described, for example, in EP 0 372 905 A2, the disclosure content of which is incorporated in the description of the present invention.

In another configuration, it may also be provided that the at least one beam splitter is configured for splitting the light emitted from the light source into two—preferably perpendicular—polarized partial beams, whereby one partial beam has the desired polarization and the other partial beam has an undesired polarization. In such a case, at least one other optical element is provided in order to transform the light with the undesired polarization into the desired polarization. Subsequently, the two now equally polarized partial beams are superimposed. The partial beams superimposed in this way can then be cast onto the LCD matrix directly adjacent to one another spatially. Such a solution is described, for example, in EP 0 376 395 A2, the disclosure content of which is incorporated in the description of the present invention.

If the lighting device is utilized in conjunction with an operating microscope, the latter may be an opthalmoscopic microscope, for example, so that the variable diaphragm of the lighting device can be configured, for example, also as a so-called retinal guard diaphragm.

Advantageously, it may be provided that at least one variable diaphragm is disposed within the lighting beam path, in a defined plane, particularly in a plane that is conjugated or essentially conjugated to the plane in which the patterned illumination is desired.

Advantageously it can be readily defocussed in order to approximately resolve structures.

Thus it may be provided, for example, that the variable diaphragm is found at a fixed site within the lighting beam path. Of course, it may also be provided that at least one variable diaphragm is disposed so that it can move within the lighting beam path both longitudinally and transversely.

A suitable control device can be provided advantageously for controlling the at least one variable diaphragm or at least individual regions or elements of the variable diaphragm. In particular, such a control device can provide a computer unit, so that the control of the variable diaphragm can be performed very precisely.

In another configuration, means for moving the lighting geometry—for example a diaphragm aperture—of at least one variable diaphragm can be provided, whereby the latter are provided particularly for tracking the diaphragm geometry—for example a diaphragm aperture—referred to a movement of the object to be illuminated. These means advantageously involve suitable programming means or software. Therefore, it can be achieved that the lighting geometry is “entrained” along with a movement of the object to be illuminated. This will be illustrated on the basis of a concrete, nonexclusive example.

If the variable diaphragm involves, for example, a retinal guard diaphragm and the object to be illuminated is an eye, it can be assured via suitable means, for example suitable software, that the diaphragm or a targeted darkening is fixed on a specific region of the eye, for example, on the region of the pupil. Now, if the pupil moves during an operation, the dark region of the guard diaphragm is automatically tracked by switching the corresponding points or regions of the variable diaphragm. It is assured in this way that the sensitive region of the eye is also darkened with a movement of the same, always by means of the guard diaphragm. The software solution thus has the advantage that this can be conducted automatically, which considerably facilitates the work of a surgeon.

According to another aspect of the invention, an optical observation device for imaging an object and/or an intermediate image produced by an object, in particular, a stereoscopic observation device is provided, with at least one observation beam path, having an objective element with an optical axis and an object plane for the arrangement of the object or of the intermediate image to be imaged, wherein at least one variable diaphragm is provided in the observation beam path, which is characterized by the fact that at least one variable diaphragm is configured in the form of a variable diaphragm according to the invention as described above.

Reference is also made herewith to the full extent to the preceding embodiments given for the variable diaphragm according to the invention with respect to the advantages, effects, as well as the mode of operation of the observation device according to the invention.

In the present case, the light that the variable diaphragm utilizes advantageously has its light origin in the observed object or in the light scattered by the observed object.

The variable diaphragm is constructed analogously to the corresponding variable diaphragm in the lighting beam path, which has already been explained in detail above, so that reference is also made in this respect to the corresponding embodiments.

A light-efficient diaphragm control can now be provided according to the invention also in the observation beam path of the observation device. Therefore, the selection of the diaphragm in the observation beam path can now also be flexible. By use of a variable diaphragm, which functions on the basis of electrowetting, polarization-dependent effects can be avoided. Intensity can be obtained simultaneously.

In particular, it may be additionally provided that the optical observation device has as a lighting device according to the invention, as described above.

The invention is not limited to specific configurations for the optical observation device. Likewise, the invention is not limited to a specific number of observation beam paths. For example, it may be provided that two or more observation beam paths are provided, which are combined, in particular, in the form of one or more pairs of observation beam paths. At least one variable diaphragm can be provided, for example, for every beam path. Likewise, it is also conceivable that at least one common variable diaphragm is provided for two parallel observation beam paths.

If the light is nonpolarized light, at least one variable diaphragm may have an LCD matrix, whereby a device is provided for linear polarization (polarization device) of the light emitted from the light source in the observation beam path downstream from the light source and in front of the variable diaphragm. For example, the polarization device can have at least one optical element, which is configured as a polarization-maintaining element.

Advantageously, at least one variable diaphragm may have an LCD matrix, whereby the LCD matrix is formed as at least one flat matrix with a number of opto-electronic LCD cells and wherein means for the electronic control of the LCD cells are provided.

Preferably, at least one variable diaphragm can be configured on the basis of electrowetting in the observation beam path. It is advantageously provided that at least one variable diaphragm in the observation beam path has at least one uptake container, which contains a first medium that is flexible in shape and a second medium that is flexible in shape, whereby the media are immiscible and come into contact at an interface, and whereby, in addition, means are provided for changing the size and/or shape of the interface between the media. In this case, the first medium that is flexible in shape and the second medium that is flexible in shape have the same or approximately the same density in order to compensate for gravitational differences.

Advantageously, the first medium that is flexible in shape and the second medium that is flexible in shape have different electrical conductivities, whereby the medium with the lower electrical conductivity is disposed between the medium with the higher electrical conductivity and at least one electrode and whereby, by applying an electrical field between the one electrical electrode and the medium with the greater electrical conductivity, the interface between the two media that are flexible in shape is changed.

Preferably, the at least one variable diaphragm in the observation beam path can have a matrix of controllable points, in which the points are formed from a number of independent drops of one of the media that are flexible in shape, in particular the medium that is flexible in shape and has a lower electrical conductivity and whereby the drops are surrounded by the other medium that is flexible in shape, in particular the medium with a higher electrical conductivity. Of course, it is also conceivable that the second medium that is flexible in shape and has the lower electrical conductivity is formed as a continuous film, as this has already been explained above in connection with the lighting device according to the invention. Reference is made in this respect to the corresponding embodiments. In another configuration, it may also be provided that the at least one variable diaphragm in the observation beam path is formed as a matrix of controllable cells, wherein each cell can be configured in the way as described above.

Preferably, at least one variable diaphragm is disposed in a defined plane, in particular the pupil plane, within the observation beam path. The variable diaphragm can be fixed, for example, in the observation beam path. Of course, it is also conceivable that at least one variable diaphragm is arranged so that it can be moved within the observation beam path.

Advantageously, a control device can be provided for controlling the at least one variable diaphragm. In addition, the control of the variable diaphragm can be used for the purpose of suppressing disruptive light reflections, which can cause very serious problems, in particular in a video operating microscope with its linear light-intensity detectors. Advantageously, an active control loop is provided, which establishes a saturation of the detector pixels and the corresponding pixels of the matrix of the variable diaphragm are switched darker in the observation beam path.

According to yet another aspect of the invention, an optical observation apparatus is provided, which is characterized according to the invention by a variable diaphragm according to the invention as described above and/or by a lighting device according to the invention as described above and/or by an observation device according to the invention as described above.

Advantageously, the optical observation apparatus is an apparatus for imaging an object and/or an intermediate image produced by an object, for example, a microscope or similar device. The observation apparatus may be configured, in particular, as a stereoscopic observation apparatus. Particularly advantageously, the optical observation apparatus is configured as an operating microscope, for example, as an operating microscope that can be utilized in the opthalmologic field, in the neuro field, in the ENT field, in the dental field or for similar applications.

The lighting device according to the invention is created for an optical apparatus, whereby the invention is not limited to specific types of optical apparatuses. For example, the lighting device can be utilized overall where a patterned, selective illumination is necessary. The lighting device can be used both in the medical field as well as also in the nonmedical field. Several nonexclusive examples will be described below. It is conceivable, for example, to utilize the lighting device in the surrounding field for cancer treatment, wart removal, surface hair removal, patterned skin tanning, or similar applications. The lighting device according to the present invention, however, may also be used for labeling specific sites on surfaces, as a chopper/shutter replacement or similar object. It is also possible with the lighting device according to the invention to blend in internal structures, e.g., in a body, in a building, in a vehicle, in a machine or the like. Such a lighting device may also be utilized for repair or maintenance purposes, for example, in order to find something more rapidly.

In particular, the lighting device may be utilized for an optical observation device for imaging an object and/or an intermediate image produced by an object, which involves a microscope, for example, e.g., an operating microscope or similar microscope.

The invention will now be explained in more detail based on the embodiment examples with reference to the attached drawing. Herein is shown:

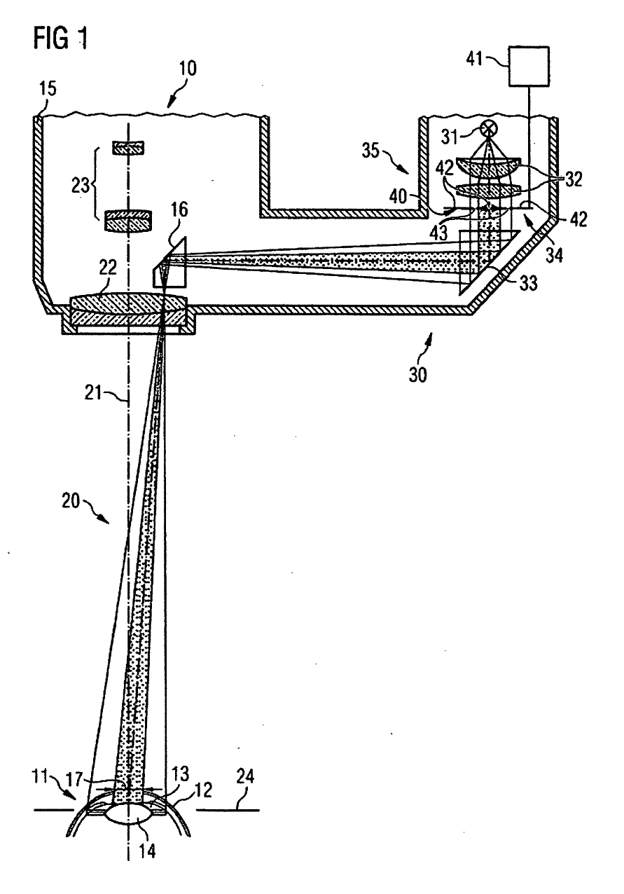

FIG. 1 an observation beam path as well as a lighting beam path within an operating microscope in which the present invention is implemented;

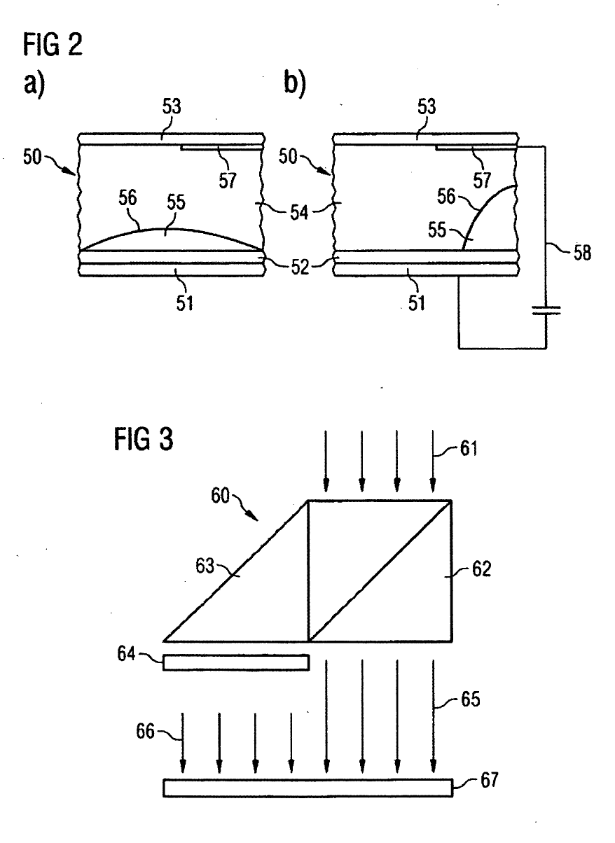

FIG. 2 a schematic diagram for explaining the principle of electrowetting;

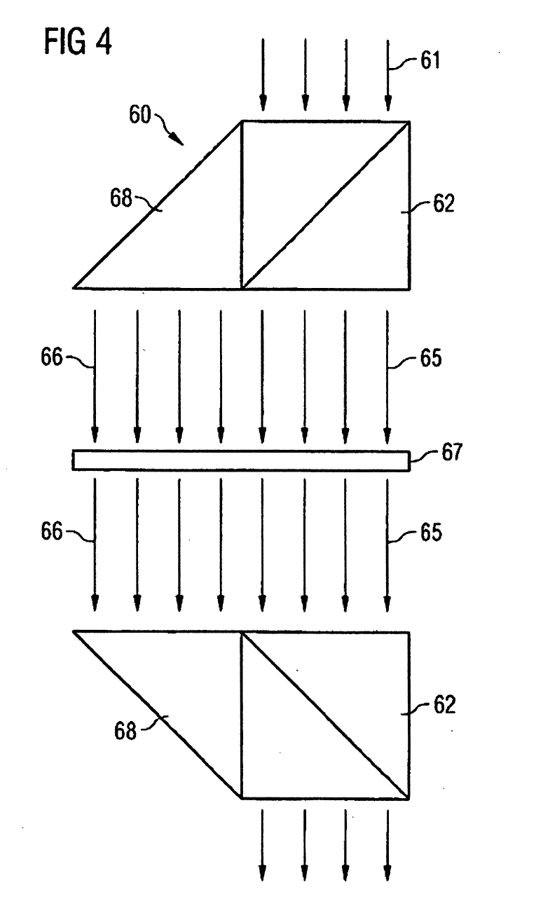

FIG. 3 a lighting beam path with a variable diaphragm configured as an LCD matrix as well as a polarization device connected upstream according to a first embodiment; and

FIG. 4 a lighting beam path with a variable diaphragm configured as an LCD matrix as well as a polarization device connected upstream according to a second embodiment;

An excerpt from an optical observation apparatus 10 is shown in FIG. 1, whereby the latter is formed as an operating microscope, in the present example as an opthalmologic microscope for eye surgeries. Operating microscope 10 has at least one observation beam path 20 and a lighting beam path 30 of a lighting device 35. Lighting device 35 as well as the optical elements of observation beam path 20 are found in a microscope housing 15.

The object 11 to be examined, in the present example an eye, for which the cornea 12, the iris 13 and the lens 14 are also shown, is found in an object plane 24. The object 11 to be examined is found in the optical axis 21 of the observation beam path 20, in which an objective element 22 as well as additional optical elements in the form of intermediate lenses 23 are also disposed, which can represent a magnification system, for example.

The object 11 to be examined is illuminated by lighting device 35 and the lighting beam path 30 that is produced. For this purpose, first a light source 31 is provided, which emits the illumination light. The lighting beam path 30 passes through an illumination optics, which has a condenser system 32. The lighting beam path 30 is directed onto the object 11 to be examined via deflecting elements 33 and 16.

In the case of operating microscopes with intense illumination, the danger may occur that the object 11 to be examined, in the present case the patient's eye, is stressed too intensely by the illumination rays. It is thus necessary to avoid possible adverse effects or damage to the eye 11.

An element 40 for producing an incident light aperture (diaphragm) is provided for this purpose in the lighting beam path 30.

The diaphragm 40 is disposed in a defined plane 34 within the lighting beam path 30, which, in the present example, involves a plane that is conjugated or essentially conjugated to the object plane and in which the patterned illumination is desired. The diaphragm 40 has transparent regions 43, through which the lighting beam path 30 can pass. In addition, diaphragm 40 has nontransparent regions 42, through which no illumination light can pass. By means of an appropriate selection of nontransparent regions 42, a defined, dimensioned shading 17 can be produced at the eye 11 to be examined, which preferably corresponds to the pupil diameter of the patient's eye 11. Diaphragm 40 may therefore involve a retinal guard diaphragm.

In the present case, diaphragm 40 is formed as a variable diaphragm, which means that a variable incident-light aperture can be produced. Diaphragm 40 may be fixed or disposed so that it can be moved in lighting beam path 30. In order to be able to adjust variable diaphragm 40 as needed, whereby different light-dark regions and lighting field geometries can be produced, variable diaphragm 40 consists of a matrix of switchable points. For example, it may involve a matrix of LCD cells. In another configuration, it may involve a matrix that functions according to the so-called electrowetting principle. These two principles are explained in detail in connection with FIGS. 2 and 3.

A diaphragm configured in this way is advantageously electronically controlled, which can be carried out by means of an appropriate control device 41. The variable diaphragm 40 or its points is (are) controlled by means of control device 41, whereby each point can be controlled individually. In this way, it is made possible that each individual point can be varied in its light transmission by means of the control, so that the desired shadings on the patient's eye 11 can be produced in a simple way.

At least one variable diaphragm 40 is provided in the lighting beam path 30. It is also possible that at least one variable diaphragm 40 is provided in the observation beam path 20.

The basic mode of operation of electrowetting will now be described in connection with FIG. 2. Two different media 54, 55, which are flexible in shape, but which have a density that is at least similar, are found in an uptake container 50. The two media, which involve liquids in the present example, are immiscible and come into contact at an interface 56. The first medium 54 involves an electrically conductive medium such as water or water having a salt addition, for example. This first medium is transparent. The second medium 55 involves an electrically less conductive to electrically insulating medium, for example, an oil. The second medium 55 will not be transparent.

The uptake container 50 is bounded by a cover element 53 as well as a substrate 52, which involves, for example, a dielectric layer, and on the bottom side of which (the surface turned away from the inside container space) at least one first electrode 51 is disposed. These above-named elements may preferably be at least partially transparent.

Inside the uptake container 50 and connected with the electrically conductive medium 54, there is provided at least one second electrode 57. An electrical field 58 can be generated by means of the two electrodes 51, 57. In the presence of such an electrical field 58, which is brought about by a voltage between the electrically conductive medium 54 (via electrode 57) and electrode 51, the wetting of the first medium 54 can be essentially varied.

In the initial state according to FIG. 2a, the electrically nonconductive, nontransparent medium 55 covers the entire substrate 52. A light beam entering via the transparent cover element 53 consequently cannot pass through the uptake container 50. Upon application of a voltage, the wettability of the surface on which the electrically conductive medium 54 lies is increased, whereby the interface 56 between the two media 54, 55 changes. This state is shown in FIG. 2b. Medium 55 then has an essentially more compact contour. Medium 55 “migrates” and releases a part of the transparent substrate 52, so that a light beam can pass through the cover element 53, the transparent first medium 54, the transparent substrate 52 and the transparent electrode 51. A light transmission is brought about.

Loading with a suitable voltage can be carried out via the control device 41 (FIG. 1), so that the light transmission of the variable diaphragm can be controlled pointwise and precisely by this means.

A solution is presented in FIG. 3, in which the variable diaphragm 40 of FIG. 1 is constructed in the form of an LCD matrix, comprised of a number of LCD cells 67. In addition to the LCD matrix, a polarization device 60 is provided in order to convert nonpolarized light into polarized light with little loss.

Light in the form of nonpolarized light rays 61 is emitted from light source 31 (FIG. 1). The nonpolarized light rays pass through a beam splitter 62, where they are spatially divided into two partial beams with different polarization. One of the partial beams 65 with the desired polarization passes through the beam splitter 62 and is cast onto the LCD matrix. The other partial beam with the undesired polarization is introduced via a deflecting element 63 into an optical element 64 for rotating the direction of polarization. There, the direction of polarization is rotated, for example by 90°, so that the partial beam 66 exiting the optical element 64 now has the same direction of polarization as partial beam 65. The two partial beams 65, 66 can now be superimposed and can be cast onto the LCD matrix directly adjacent to one another spatially.

Finally, another solution is presented in FIG. 4, in which the variable diaphragm 40 of FIG. 1 is constructed in the form of an LCD matrix, comprised of a number of LCD cells 67. In addition to the LCD matrix, a polarization device 60 is provided.

The variable diaphragm 40 will be found this time in the observation beam path 20 (FIG. 1) of the operating microscope 10. The light that the variable diaphragm 40 utilizes this time has its origin in the observed object or in the light scattered by the observed object.

The light rays 61 pass through a beam splitter 62, where they are spatially divided into two partial beams. One of the partial beams 65 passes through the beam splitter 62 and is cast onto the LCD matrix 67. The other partial beam 66 is deflected via a mirror 68 maintaining the polarization and is also [cast]* onto the LCD matrix 67. Another mirror 68 maintaining the polarization as well as another beam splitter 62 are provided in the beam path downstream from the LCD matrix 67, in order to again influence the course of partial beams 65, 66.
* The word “cast” is presumably omitted in error in the original German text—Trans. Note.

Such an arrangement could also be provided, for example, in a lighting beam path 30 (FIG. 1), for example, if any type of polarization effect must be avoided there.

A light-efficient diaphragm control can be produced in a particularly advantageous way according to the present invention in the lighting beam path and/or in the observation beam path of the operating microscope 10.

### LIST OF REFERENCE NUMERALS

10 Optical observation apparatus (operating microscope)
11 Object (eye)
12 Cornea
13 Iris
14 Lens
15 Housing
16 Deflecting element
17 Shading
20 Observation beam path
21 Optical axis
22 Objective element
23 Intermediate lens
24 Object plane
30 Lighting beam path
31 Light source
32 Condenser system
33 Deflecting element
34 Defined plane
35 Lighting device
40 Variable diaphragm
41 Control device
42 Non-transparent region
43 Transparent region
50 Uptake container
51 First electrode
52 Substrate layer
53 Cover element
54 First medium that is flexible in shape (water)
55 Second medium that is flexible in shape (oil)
56 Interface between the media
57 Second electrode
58 Electrical field
60 Polarization device
61 Nonpolarized light
62 Beam splitter
63 Deflecting element
64 Optical elements for rotating polarization
65 Polarized partial beam
66 Polarized partial beam
67 LCD cells
68 A mirror maintaining the polarization

1. A variable diaphragm for a lighting device and/or an optical observation device within an optical observation apparatus for imaging an object and/or an intermediate image produced by an object, wherein the variable diaphragm is provided for at least one beam path of the lighting device and/or the observation device is hereby characterized in that the variable diaphragm for producing a specific lighting geometry can be controlled by regions and that the variable diaphragm is configured for utilization of all directions of polarization of the light of a light source.

2. The variable diaphragm according to claim 1, further characterized in that the variable diaphragm is configured such that light of a light source that passes through it has an effectiveness of greater than 40%.

3. The variable diaphragm according to claim 1, further characterized in that the variable diaphragm is configured for the reflection and/or for the transmission of light.

4. The variable diaphragm according to claim 1, further characterized in that the variable diaphragm is formed as an active optical element and that a light source is integrated into the variable diaphragm.

5. The variable diaphragm according to claim 4, further characterized in that the variable diaphragm is formed of a matrix of miniature light sources that can be switched on by regions.

6. The variable diaphragm according to claim 5, further characterized in that the variable diaphragm is formed of a matrix of light diodes (LEDs) that can be switched on by regions, in particular organic light diodes (OLEDs).

7. The variable diaphragm according to claim 1, further characterized in that the variable diaphragm is formed as a passive optical element.

8. The variable diaphragm according to claim 7, further characterized in that the variable diaphragm has an LCD matrix.

9. The variable diaphragm according to claim 7, further characterized in that the variable diaphragm is formed on the basis of electrowetting.

10. The variable diaphragm according to claim 9, further characterized in that the variable diaphragm has at least one uptake container, which contains a first medium that is flexible in shape and a second medium that is flexible in shape, whereby the media are immiscible and come into contact at an interface and that means for changing the size and/or shape of the interface between the media are provided.

11. The variable diaphragm according to claim 10, further characterized in that the first medium that is flexible in shape and the second medium that is flexible in shape have the same density.

12. The variable diaphragm according to claim 9, further characterized in that the first medium that is flexible in shape and the second medium that is flexible in shape have different electrical conductivities, that the medium with the lower electrical conductivity is disposed between the medium with the higher electrical conductivity and at least one electrode and that by applying an electrical field between the at least one electrode and the medium with the higher electrical conductivity, the interface between the two media that are flexible in shape is changed.

13. The variable diaphragm according to claim 9, further characterized in that the variable diaphragm has a matrix of controllable points, in which the points are formed from a number of independent drops of one of the media that are flexible in shape, in particular the medium that is flexible in shape and has a lower electrical conductivity, and that the drops are surrounded by the other medium that is flexible in shape, in particular the medium with a higher electrical conductivity.

14. The variable diaphragm according to claim 9, further characterized in that the variable diaphragm has a matrix of controllable cells.

15. A lighting device for producing a patterned illumination for an optical observation apparatus for imaging an object and/or an intermediate image produced by an object, in particular for a stereoscopic observation apparatus, with a light source and with at least one variable diaphragm provided in a lighting beam path, is hereby characterized in that the lighting device has at least one variable diaphragm according to claim 1.

16. The lighting device according to claim 15, further characterized in that at least one variable diaphragm is formed as a passive optical element, that the light source is disposed in the lighting beam path in front of the at least one variable diaphragm and that light emitted from light source is deflected onto an object through the at least one variable diaphragm.

17. The lighting device according to claim 16, further characterized in that an illumination optics is provided between the light source and the at least one variable diaphragm.

18. The lighting device according to claim 15, further characterized in that at least one variable diaphragm has an LCD matrix and that a device for linear polarization (polarization device) of the light emitted from light source is provided in the lighting beam path downstream from light source and in front of the variable diaphragm.

19. The lighting device according to claim 15, further characterized in that at least one variable diaphragm has an LCD matrix, that the LCD matrix is formed as at least one flat matrix with a number of opto-electronic LCD cells and that means for the electronic control of the LCD cells are provided.

20. The lighting device according to claim 18, further characterized in that the polarization device is a component of the illumination optics and that the optical elements of the illumination optics, which lie in the lighting beam path between the polarization device and the variable diaphragm are formed as polarization-maintaining elements.

21. The lighting device according to claim 18, further characterized in that the polarization device has at least one beam splitter for splitting the light emitted by light source into two or more partial beams with different polarization directions.

22. The lighting device according to claim 21, further characterized in that at least one optical element is provided that is disposed downstream from the beam splitter, in order to cast the two separate partial beams of different polarity adjacent to one another onto the LCD matrix.

23. The lighting device according to claim 15, further characterized in that at least one variable diaphragm is disposed within the lighting beam path in a defined plane, in particular in a plane that is conjugated or is essentially conjugated to the plane in which the patterned illumination is desired.

24. The lighting device according to claim 15, further characterized in that at least one variable diaphragm is disposed so that it can move within the lighting beam path.

25. The lighting device according to claim 15, further characterized in that a control device is provided for controlling the at least one variable diaphragm.

26. The lighting device according to claim 15, further characterized in that means are provided for moving the lighting geometry of at least one variable diaphragm, in particular for tracking the lighting geometry relative to a movement of object to be illuminated.

27. An optical observation device for imaging an object and/or an intermediate image produced by an object, in particular a stereoscopic observation device, with at least one observation beam path, having an objective element with an optical axis and an object plane for arranging the object to be imaged or the intermediate image, wherein at least one variable diaphragm is provided in the observation beam path, is hereby characterized in that at least one variable diaphragm is configured according to claim 1.

28. The optical observation device according to claim 27, further characterized in that the light which is utilized by the variable diaphragm has its light origin in the observed object or in the light scattered by the observed object.

29. The optical observation device according to claim 27, further characterized in that it has two or more observation beam paths, in particular one or more pairs of observation beam paths, and that at least one variable diaphragm is provided for each beam path and/or that at least one common variable diaphragm is provided for two parallel observation beam paths.

30. The optical observation device according to claim 27, further characterized in that at least one variable diaphragm has an LCD matrix and that a device for the linear polarization (polarization device) of the light emitted from the light source is provided in the observation beam path downstream from the light source and in front of the variable diaphragm.

31. The optical observation device according to claim 27, further characterized in that at least one variable diaphragm has an LCD matrix, that the LCD matrix is formed as at least one flat matrix with a number of opto-electronic LCD cells and that means for the electronic control of the LCD cells are provided.

32. The optical observation device according to claim 30, further characterized in that the polarization device has at least one optical element, which is formed as a polarization-maintaining element.

33. The optical observation device according to 27, further characterized in that at least one variable diaphragm is formed in the observation beam path based on electrowetting.

34. The optical observation device according to claim 33, further characterized in that at least one variable diaphragm in the observation beam path has at least one uptake container which contains a first medium that is flexible in shape and a second medium that is flexible in shape, whereby the media are immiscible and come into contact at an interface and that means are provided for changing the size and/or shape of interface between media.

35. The optical observation device according to claim 34, further characterized in that the first medium that is flexible in shape and the second medium that is flexible in shape have the same density.

36. The optical observation device according to claim 34, further characterized in that the first medium that is flexible in shape and the second medium that is flexible in shape have different electrical conductivities, that the medium that has the lower electrical conductivity is disposed between the medium with the higher electrical conductivity and at least one electrode and that the interface between the two media that are flexible in shape is changed by applying an electrical field between the at least one electrode and the medium with the higher electrical conductivity.

37. The optical observation device according to claim 27, further characterized in that the at least one variable diaphragm in the observation beam path has a matrix of controllable points, wherein the points are formed from a number of independent drops of one of the media that are flexible in shape, in particular medium that is flexible in shape and has a lower electrical conductivity, and that the drops are surrounded by the other medium that is flexible in shape, in particular medium that has a higher electrical conductivity.

38. The optical observation device according to claim 27, further characterized in that the at least one variable diaphragm in the observation beam path has a matrix of controllable cells.

39. The optical observation device according to claim 27, further characterized in that at least one variable diaphragm is disposed in a defined plane, in particular the pupil plane, within the observation beam path.

40. The optical observation device according to claim 27, further characterized in that at least one variable diaphragm is disposed so that it can move within the observation beam path.

41. The optical observation device according to claim 27, further characterized in that a control device is provided for controlling the at least one variable diaphragm.

42. An optical observation apparatus, characterized by at least one variable diaphragm according to claim 1 and/or at least one lighting device according to claim 15 and/or at least one observation device according to claim 27.

43. The optical observation device according to claim 42, further characterized in that the latter is configured as a microscope, in particular as an operating microscope.
